(19) United States
(12) Patent Application Publication
(10) Pub. No.: US 2026/0237573 A1
(43) Pub. Date: Aug. 13, 2026

(54) LOCKING DEVICE FOR A ROCKER-TYPE LIGHT SWITCH

(71) Applicant: Toggle Shield LLC, East Lansing, MI (US)

(72) Inventor: ATA SHIRAVI, FARMINGTON HILLS, MI (US)

(73) Assignee: Toggle Shield LLC, East Lansing, MI (US)

(21) Appl. No.: 19/049,753

(22) Filed: Feb. 10, 2025

(51) Int. Cl. H01H 9/20; H01H 23/12

(52) U.S. Cl. CPC H01H 9/20; H01H 23/12

(57) ABSTRACT

A locking device for a rocker-type light switch is disclosed. It is intended to prevent the actuator of the rocker-type light switch from moving. The locking device has a locking feature that is sized so that it fits into an air-gap between the actuator and an actuator rim. When the locking feature is inserted into the air-gap, it engages with the actuator, preventing the actuator from moving.

### FIELD OF INVENTION

This invention relates to classifications for electric switches and to one or more sub-classifications for interlocking, locking, or latching mechanisms. Specifically, this invention is a locking device for a rocker-type light switch.

### BACKGROUND OF INVENTION

Most switches in use today are secured in an outlet box in a wall or in a machine. In the front surface of the switch are threaded holes, which receive screws that fasten a switch plate cover to the switch, called hereinafter switch plate screws. These switch plate screws are inserted through holes in the switch plate. An opening or cutout is provided in the switch plate through which the actuator member of a rocker-type light switch protrudes. A problem arises with switches which control lights in areas where the lights must be kept on, or off, for periods of time, or which control other electrical devices, such as burglar alarms and security cameras, in which the rocker-type light switch can be accidentally operated by a person.

There are few prior art patents for inventions designed to prevent accidental operation of rocker-type light switches. Almost all such prior art describes devices which require installation by attachment to a switch plate to anchor the device to either cover the actuator member or lie against the actuator member of the switch. Such devices are often not useful with switch plate designs that lack screws or features onto which the device may attach. Moreover, installation to a switch plate using tools, such as a screwdriver, increases the possible risk of electrical shock if the switch electrically shorts. For example, through the switch plate screws, due to improper installation or a damaged switch. This can result in a hazardous condition, especially where the device is of an electrically conductive material. In addition, most of the prior art inventions are time-consuming to install and will change the appearance of the environment they are in.

What the market needs is a snap-on lock to secure rocker-type light switch covers. Preferrably, a device that does not require tools, is flush with the rocker-type light switch, and blends with the home and office décor.

### SUMMARY OF THE INVENTION

This summary is intended to disclose the present invention, a locking device for a rocker-type light switch. Embodiments of the invention are presented to illustrate and inform one skilled in the art.

The present invention is a locking device for a rocker-type light switch. It is intended to prevent the actuator from moving.

A locking device for a rocker-type light switch comprises an integral body having a first side surface defined by a piece-wise edge; a second side surface defined by a piece-wise edge that mirrors the piece-wise edge of the first side surface; a plurality of surfaces that adjoin both the first side surface and second side surface and which conform to the piece-wise edges defining each of the first side surface and second side surface, respectively; and a locking feature incorporated into at least one of the plurality of surfaces.

The locking device in proximity to the locking feature is sized so that it fits into the air-gap between an actuator and an actuator rim on a rocker-type light switch. An actuator will have a first position and a second position. When the locking device is inserted into the air-gap between the actuator and the actuator rim on a rocker-type light switch, the locking feature, when engaged, prevents the actuator from moving from the first position to the second position.

The first position can be the “on” position for a rocker-type light switch. Alternately, the first position can be the “off” position for the rocker-type light switch. It depends how the rocker-type light switch is designed and how it is wired. Rocker-type light switches come in either single or dual packages, meaning they have either one or two actuators. Each actuator controls its own light or electrical receptacle.

The locking devices comes in two embodiments. In the first embodiment, the locking feature consists of at least one protrusion extending from a planar surface. The protrusions engage with the actuator, preventing the actuator from moving from the first position to the second position. In the second embodiment, the locking feature consists of a triangular-shaped locking tab. The second embodiment has a notch adjacent to the locking tab. The first embodiment of the locking device works with both a single actuator rocker-type light switch and a dual actuator rocker-type light switch.

When applied to the single actuator rocker-type light switch, the first embodiment of the locking device is inserted into either an upper air-gap or a bottom air-gap, depending on whether the actuator is in its first position or second position. When applied to a dual actuator rocker-type light switch, the second embodiment of the locking device is inserted into either a first air-gap or a second air-gap.

When applied to the single actuator rocker-type light switch, the second embodiment of the locking device is inserted into a side air-gap. The purpose of the second embodiment of the locking device is to further secure a single actuator rocker-type light switch. Applying only the first embodiment, as described above, can sometimes not fully lock the actuator. The second embodiment of the. locking device can be moved along the actuator rim until such time as the notch and the locking tab are fully engaged, preventing the actuator from moving.

The locking device has a grasping feature formed by at least two of the plurality of surfaces. After being inserted into a rocker-type light switch and engaging with the actuator, the locking device can removed by grasping the grasping feature and pulling. The locking feature can be inserted into the rocker-type light by grasping the grasping feature and pushing the locking feature into the air-gap until the locking feature engages with the actuator.

The locking device for a rocker-type light switch is fabricated from at least one of polyvinyl chloride (“PVC”), polypropylene (“PP”), acrylonitrile butadiene styrene (“ABS”), polycarbonate (“PC”), nylon, high-density polyethylene (“HDPE”), low-density polyethylene (“LDPE”), polyethylene terephthalate (“PET”) and a thermoplastic elastomer (“TPE”).

### BRIEF DESCRIPTION OF THE DRAWINGS

The present invention is illustrated with 11 drawings on 8 sheets. The accompanying drawings, which are incorporated in and constitute a part of this disclosure, illustrate various example embodiments. In the drawings: FIGS. 1A is a side view of a first embodiment of the present invention. FIG. 1B is a side view of a second embodiment of the present invention. FIG. 2A is a perspective view of the first embodiment of the present invention. FIG. 2B is a perspective view of the second embodiment of the present invention. FIG. 3A is a top view of the first embodiment of the present invention. FIG. 3B is a top view of the second embodiment of the present invention. FIG. 4A is a bottom-perspective view of the first embodiment of the present invention. FIG. 4B is a bottom-perspective view of the second embodiment of the present invention. FIG. 5A is a side-perspective view of the first embodiment of the present invention. FIG. 5B is a front-perspective view of the second embodiment of the present invention. FIG. 6A is a front view of the first embodiment of the present invention. FIG. 6B is a front view of the second embodiment of the present invention.

FIG. 7A is a front view of a dual rocker-type light switch, with both actuators in a first position. FIG. 7B is a front view of a dual rocker-type light switch, with the top actuator in the first position and the bottom actuator in the second position. FIG. 7C is a first side view of a dual rocker-type light switch. FIG. 7D is a second side view of a dual rocker-type light switch.

FIG. 8A is a front view of a single rocker-type light switch. FIG. 8B is a side view of a single rocker-type light switch.

FIG. 9 is a front view of the present invention being applied to a dual rocker-type light switch on the left and a single rocker-type light switch on the right.

FIG. 10A is a side view of a dual rocker-type light switch with the present invention applied to one actuator. FIG. 10B is a front view of a dual rocker-type light switch with the present invention applied to one actuator. FIG. 10C is a front isolation of the present invention being applied to one actuator of a dual rocker-type light switch.

FIG. 11A is an isolation perspective view of a single rocker-type light switch with the present invention applied to the actuator. FIG. 11B is a reverse isolation perspective view of a single rocker-type light switch, in comparison to FIG. 11A, with the present invention applied to the actuator.

### DETAILED DESCRIPTION OF THE DRAWINGS

The following descriptions are not meant to limit the invention, but rather to add to the summary of invention, and illustrate the present invention, a locking device for a rocker-type light switch. The present invention is illustrated with a variety of drawings showing the primary embodiments of the present invention, with various diagrams and figures explaining its workings. The drawings are those needed to help one skilled in the art to understand and replicate the present invention.

Certain terminology is used in the following description for convenience only and is not limiting. The article “a” is intended to include one or more items, and where only one item is intended the term “one” or similar language is used. To assist in the description of the present invention, words such as short, long, top, bottom, side, upper, lower, front, rear, inner, outer, right and left are used to describe the relative size and orientation of the present invention, locking device for a rocker-type light switch, with respect to the accompanying figures. The terminology includes the words above specifically mentioned, derivatives thereof, and words of similar import.

The following detailed description refers to the accompanying drawings. Wherever possible, the same reference numbers are used across the descriptions of the drawings and embodiments to refer to the same or similar elements. The embodiments of the claimed subject matter may be described, modified, and adapted, and other implementations are possible. For example, substitutions, additions, or modifications, which, perform identical functions to the embodiments disclosed, may be made to the elements illustrated in the drawings. Accordingly, the following detailed description does not limit the claimed subject matter. The proper scope of the claimed subject matter is defined by the claims contained herein. The claimed subject matter improves over the prior art by providing a locking device for a rocker-type light switch which is easy to affix and remove, while still locking the actuator when in situ.

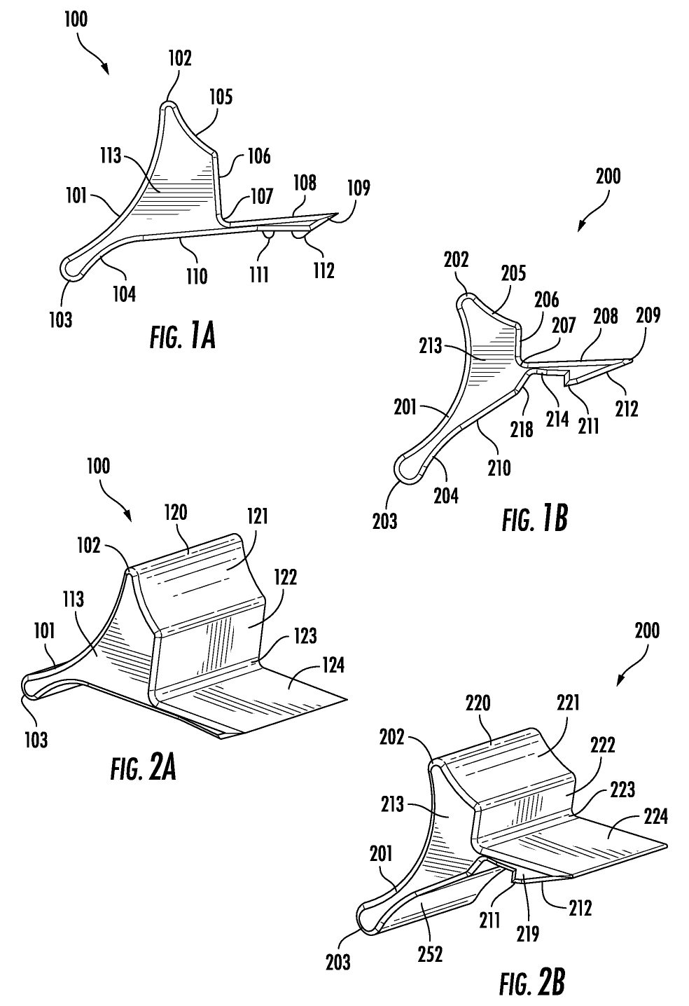

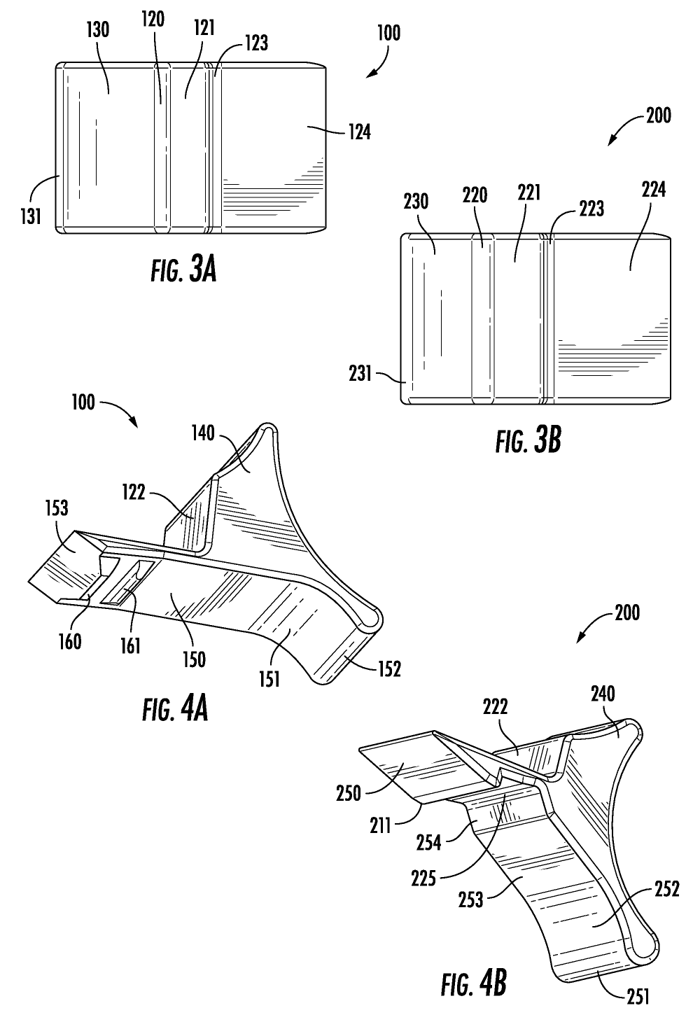

FIGS. 7A-7D illustrate a dual rocker-type light switch 300. The dual rocker-type light switch 300 has a housing 323 terminating in an inner rim 310. Protruding from the housing 323 are a plurality of electrical terminals 320, 321, 322, 330, 331 to which electrical wires are intended to be attached during operation. The dual rocker-type light switch 300 has an upper mount 304 and a lower mount 303 which affix the dual rocker-type light switch, with a screw 324, into a switch box (not shown). The switch box is permanently affixed within the wall.

A dual rocker-type light switch 300 has a first actuator 301 and a second actuator 302. In FIG. 7A, both the first actuator 301 and the second actuator 302 are in a first position 301, 302. The first position 301, 302 will correspond to either the rocker-type light switch actuator 301, 302 being “on” or the rocker-type light switch actuator 301, 302 being “off”, depending on how the rocker-type light switch 300 is wired. In FIG. 7B, the first actuator 301 remains in a first position 301, while the second actuator 302' is in a second position 302'.

The rocker-type light switch 300 has an actuator rim 305 that encompasses both actuators 301, 302. There is a first small air-gap 306 between the first actuator 301 and the actuator rim 305; there is a second small air-gap 308 between the first actuator 301 and the actuator rim 305. Likewise, there is a first small air-gap 307 between the second actuator 302 and the actuator rim 305 and there is a second small air-gap 309 between the second actuator 302 and the actuator rim 305.

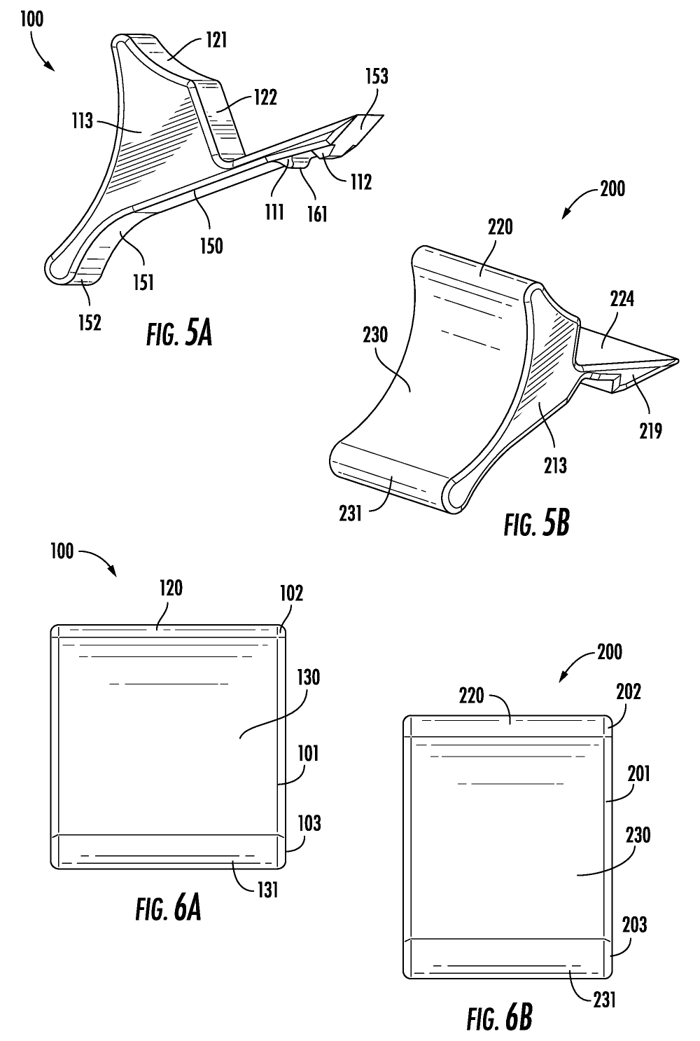

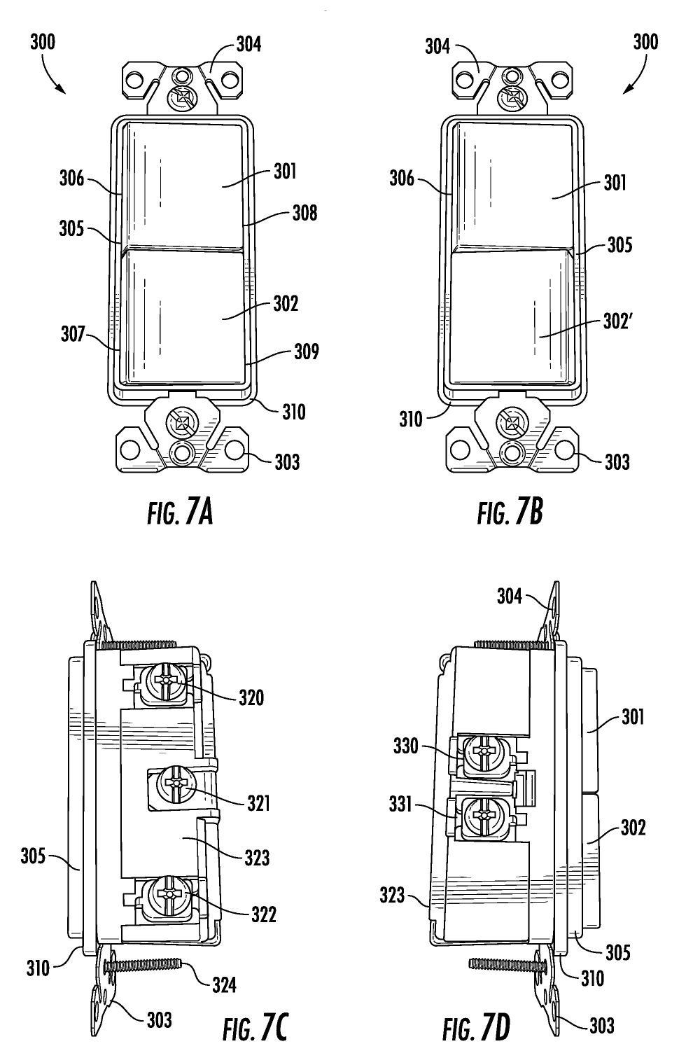

FIGS. 8A and 8B show an illustration of a single rocker-type light switch 400. This single rocker-type light switch 400 has an actuator 401, an upper mount 404, a lower mount 403, a housing 423, an actuator rim 405, an inner rim 410, a housing rim 420, and electrical terminals 424. There is an upper air-gap 407 between the actuator rim 405 and the actuator 401. There are two side air-gaps 406 between the actuator rim 405 and the actuator 401. There is a bottom air-gap 408 between the actuator rim 405 and the actuator 401. The actuator 401 is in its first position 401.

FIGS. 1A, 2A, 3A, 4A, 5A, and 6A illustrate a first embodiment of the present invention 100, a locking device for a rocker-type light switch 100 having an integral body 100. As will be discussed below, this embodiment 100 works with both a single rocker-type light switch 400 and a dual rocker-type light switch 300. FIGS. 1B, 2B, 3B, 4B, 5B, and 6B, illustrate a second embodiment of the present invention 200, a locking device for a rocker-type light switch 200. As will be discussed below, this embodiment 200 works only with a single rocker-type light switch 400.

Referring now to FIGS. 1A, 2A, 3A, 4A, 5A, and 6A, the locking device for a rocker-type light switch 100 has a first side surface 113 and a second side surface 140. Referring now to FIG. 1A, the first side surface 113 is defined by a piece-wise continuous edge 101, 102, 105, 106, 107, 108, 109, 110, 104, 103. The silhouette of two locking protrusions 111, 112 is visible. The second side surface 140 is defined by a mirrored, piece-wise continuous edge.

Referring now also to FIGS. 2A, 3A, 4A, 5A, and 6A, the present invention has an curved upper front surface 130, a curved top surface 120, a curved rear surface 121, a filleted surface 123, a planar lateral surface 122, a planar horizontal surface 124, a curved lower front surface 131, an angled surface 153, a planar bottom surface 150, a first curved bottom surface 151, and a second curved lower surface 152. The curved upper front surface 130 is a concave semi-cylinder. The curved top surface 120 is a convex semi-cylinder. The curved rear surface 121 is a concave semi-cylinder.

The curved upper front surface 130 adjoins the first side surface 113 at the edge 101. The curved upper front surface 130 transitions into the curved top surface 120. The curved upper front surface 130 also transitions into the curved lower front surface 131. The curved top surface 120 adjoins the first side surface 113 at the edge 102. The curved top surface 120 transitions into the curved rear surface 121. The curved rear surface 121 adjoins the first side surface 113 at the edge 105. The curved rear surface 121 transitions into the planar lateral surface 122. The planar lateral surface 122 adjoins the first side surface 113 at the edge 106. The planar lateral surface 122 transitions into the filleted surface 123. The filleted surface 123 adjoins the first side surface 113 at the edge 107. The filleted surface 123 transitions into the planar lateral surface 124. The planar lateral surface 124 adjoins the first side surface 113 at the edge 108. The planar lateral surface 124 transitions into the angled surface 153. The angled surface 153 adjoins the first side surface 113 at the edge 109. The angled surface 153 transitions into the planar bottom surface 150. The planar bottom surface 150 adjoins the first side surface 113 at the edge 110. The planar bottom surface 150 transitions into the first curved bottom surface 151. The first curved bottom surface 151 adjoins the first side surface 113 at the edge 104. The first curved bottom surface 151 transitions into the second curved bottom surface 152. The second curved bottom surface 153 transitions into the curved lower front surface 131. The second curved bottom surface 153 and curved lower front surface 131 share an edge 103, adjoining the first side surface 113.

Two locking protrusions 160, 161 extend outward from the planar bottom surface 150. The angled surface 153 forms a side of the first locking protrusion 160.

The first curved bottom surface 151 is disposed opposite the curved upper front surface 130. Together, these two contoured surfaces create a grasping feature 151, 130 by which the user can grasp and insert locking device for a rocker-type light switch 100 into a rocker-type light switch 300, 400.

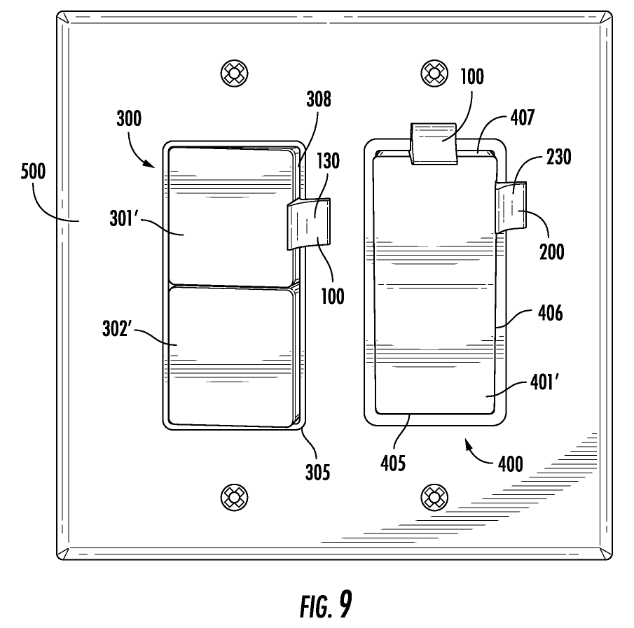

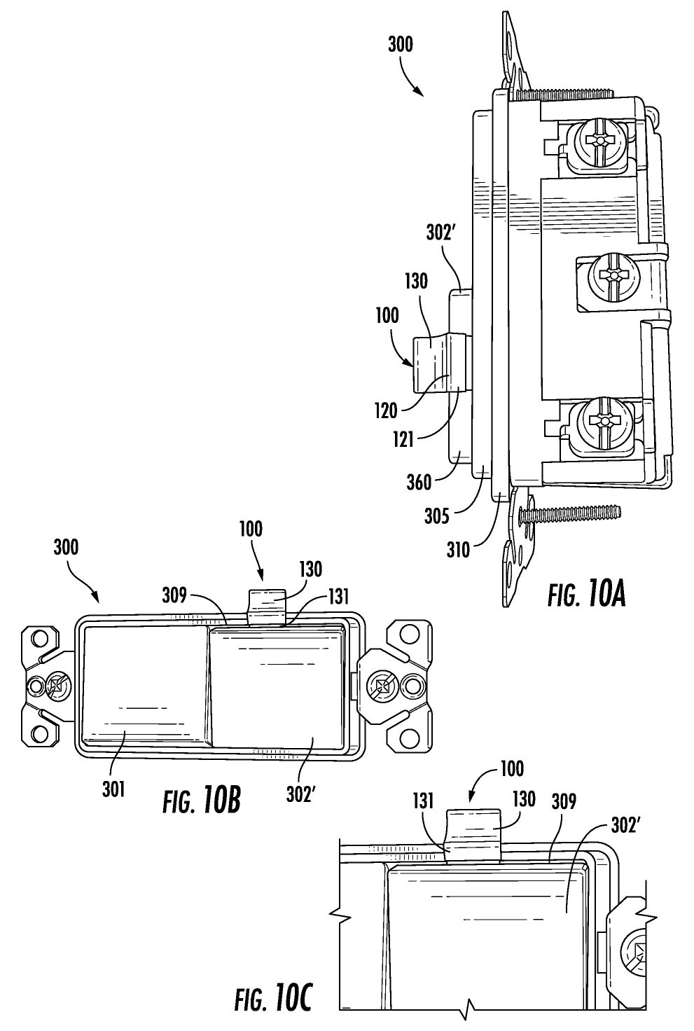

FIGS. 10A-10C show a locking device for a rocker-type light switch 100 applied to a dual rocker-type light switch 300. The locking device for a rocker-type light switch 100 applied to a dual rocker-type light switch 300 is applied to the second actuator 302' which is in its second position 302'. When the second actuator 302' is in its second position 302', a lateral surface 360 is exposed above the actuator rim 305.

The locking device for a rocker-type light switch 100 is inserted into a second air-gap 309 for the second actuator 302' with the planar lateral surface 124 facing the actuator rim 305 and the planar bottom surface 150 facing the second actuator 302'. The protrusions 160, 161 engage the underside of the second actuator 302', holding it in place. The curved upper front surface 130 and curved rear surface 121 are disposed towards the actuator rim 305 and inner rim 310 and are disposed away from the second actuator 302'. When viewed from the front (see FIGS. 10B and 10C), the curved top surface 120 is visible. The second actuator 302' is effectively locked into position until a user removes the locking device for a rocker-type light switch 100. Since no locking device for a rocker-type light switch 100 has been applied to the first actuator 301, it is unaffected.

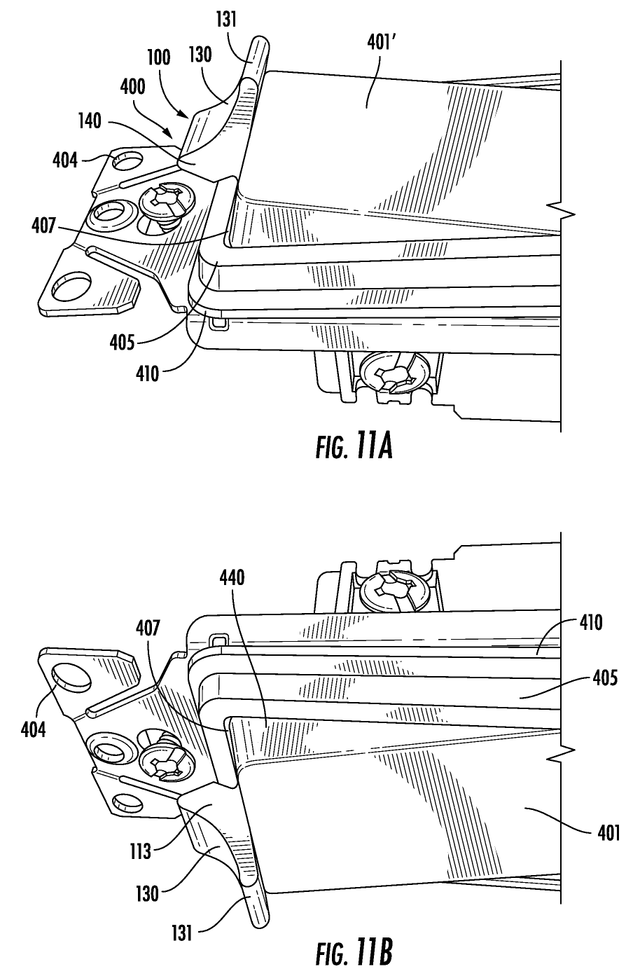

FIGS. 11A-11B show a locking device for a rocker-type light switch 100 applied to a single rocker-type light switch 400. In these isolations, just half of the rocker-type light switch 400, including the upper mount 404, is shown. In this instance, the locking device for a rocker-type light switch 100 has been applied to a single rocker-type light switch 400 in order to maintain the actuator 401' in its second position 401'. The locking device for a rocker-type light switch 100 is inserted into the upper air-gap 407 between the actuator rim 405 and the actuator 401'. When the actuator 401' is in its second position 401', a lateral surface 440 of the actuator 401' is exposed above the actuator rim 405.

The locking device for a rocker-type light switch 100 is inserted into the upper air-gap 407 for the actuator 401' with the planar lateral surface 124 facing the actuator rim 405 and the planar bottom surface 150 facing the actuator 401'. The protrusions 160, 161 engage the underside of the actuator 401', holding it in place. The curved upper front surface 130 is disposed towards the actuator rim 305 and inner rim 310 and is disposed away from the 401 actuator 401'. The curved top surface 120 is visible. The second actuator 302' is effectively locked into position until a user removes the locking device for a rocker-type light switch 100. In FIG. 11B, the second side surface 140 of the locking device for a rocker-type light switch 100 is shown. In FIG. 11A, the first side surface 113 of the locking device for a rocker-type light switch 100 is shown.

FIGS. 1B, 2B, 3B, 4B, 5B, and 6B illustrate a second embodiment of the present invention 200, a locking device for a rocker-type light switch 200. This embodiment 200 works only with a single rocker-type light switch 400.

Referring now to FIGS. 1B, 2B, 3B, 4B, 5B, and 6B, the locking device for a rocker-type light switch 200 has a first side surface 213 and a second side surface 240. Referring now to FIG. 1B, the first side surface 213 is defined by a piece-wise continuous edge 201, 202, 205, 206, 707, 208, 209, 212, 211,214, 218, 210, 204, 203. The second side surface 240 is defined by a mirrored, piece-wise continuous edge. Two of the edges 211, 212 form a locking tab 211, 212.

Referring now also to FIGS. 2A, 3A, 4A, 5A, and 6A, the present invention has a curved lower front surface 231, an curved upper front surface 230, a curved top surface 220, a curved rear surface 221, a planar lateral surface 222, a filleted surface 223, a planar horizontal surface 224, a lateral locking-tab surface 250, a notch surface 225, a bottom transition surface 254, a planar bottom surface 253, a first curved bottom surface 252, and a second curved lower surface 251. The curved upper front surface 230 is a concave semi-cylinder. The curved top surface 220 is a convex semi-cylinder. The curved rear surface 221 is a concave semi-cylinder.

The curved upper front surface 230 adjoins the first side surface 213 at the edge 201. The curved upper front surface 230 transitions into the curved top surface 220. The curved upper front surface 230 also transitions into the curved lower front surface 231. The curved top surface 220 adjoins the first side surface 213 at the edge 202. The curved top surface 220 transitions into the curved rear surface 221. The curved rear surface 221 adjoins the first side surface 213 at the edge 205. The curved rear surface 221 transitions into the planar lateral surface 222. The planar lateral surface 222 adjoins the first side surface 213 at the edge 206. The planar lateral surface transitions into the filleted surface 223. The filleted surface 223 adjoins the first side surface 213 at the edge 207. The filleted surface 223 transitions into the planar lateral surface 224. The planar lateral surface 224 adjoins the first side surface 213 at the edge 208. The planar lateral surface 224 transitions into the lateral locking-tab surface 250. The lateral locking-tab surface 250 adjoins the first side surface 213 at the edge 212. The lateral locking-tab surface 250 transitions into vertical locking-tab surface (not visible) which is defined by the edge starting at 211. The vertical locking-tab surface transitions into a notch surface 225. The notch surface 225 adjoins the first side surface 213 at the edge 214. The notch surface 225 transitions to the bottom transition surface 254. The bottom transition surface 254 adjoins the first side surface 213 at the edge 218. The bottom transition surface 254 transitions into the planar bottom surface 253. The planar bottom surface 253 adjoins the first side surface 213 at the edge 210. The planar bottom surface 253 transitions into the first curved bottom surface 252. The first curved bottom surface 252 adjoins the first side surface 213 at the edge 204. The first curved bottom surface 252 transitions into the second curved bottom surface 251. The second curved bottom surface 251 transitions into the curved lower front surface 231. The second curved bottom surface 251 and curved lower front surface 231 share an edge 203, adjoining the first side surface 213.

The locking tab 250, 211, 212 extends downward as referenced by the planar lateral surface 224. The first curved bottom surface 252 is disposed opposite the curved upper front surface 230. Together, these two surface create a grasping feature 252, 230 by which the user can grasp and insert locking device for a rocker-type light switch 200 into a single rocker-type light switch 400.

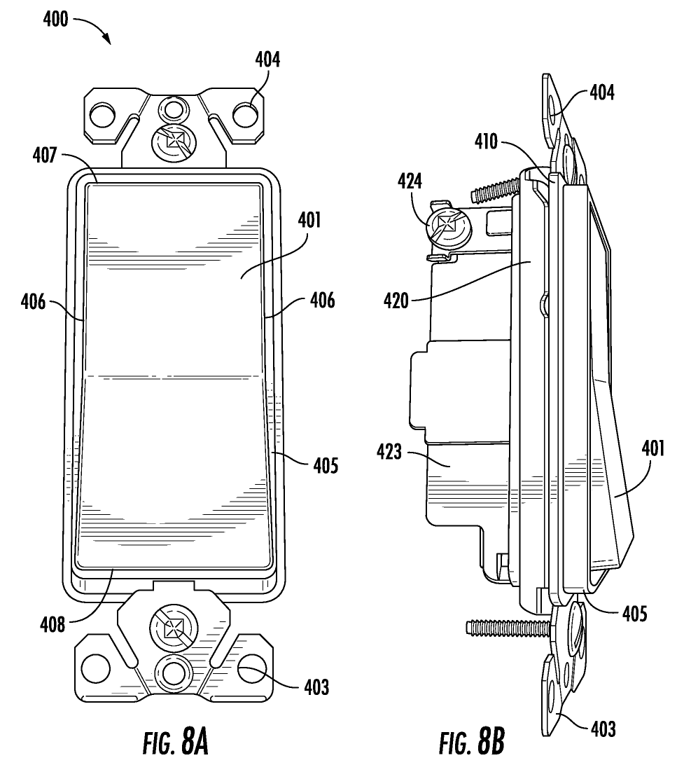

FIG. 9 shows an application of the first embodiment of a locking device for a rocker-type light switch 100 used with both a dual rocker-type light switch 300 and a single rocker-type light switch 400. With respect to the dual rocker-type light switch 300, the locking device for a rocker-type light switch 100 is inserted into the second small air-gap 308 of the first actuator 301' which is in its second position 301'. The locking device for a rocker-type light switch 100 is grasped at the two contoured surfaces 151, 130 creating a graphing feature 151, 130. The locking device for a rocker-type light switch 100 is inserted with the planar lateral surface 124 facing the actuator rim 305 and the planar bottom surface 150 facing the actuator 301'. The protrusions 160, 161 engage the actuator 301', holding it in place.

The first embodiment of a locking device for a rocker-type light switch 100 is also used with the single rocker-type light switch 400. With respect to the single rocker-type light switch 400, the locking device for a rocker-type light switch 100 is inserted into the upper air-gap 407 of the actuator 401' which is in its second position 401'. The locking device for a rocker-type light switch 100 is grasped at the two contoured surfaces 151, 130 creating a graphing feature 151, 130. The locking device for a rocker-type light switch 100 is inserted with the planar lateral surface 124 facing the actuator rim 405 and the planar bottom surface 150 facing the actuator 401'. The protrusions 160, 161 engage the actuator 401', holding it in place.

FIG. 9 also shows the second embodiment of the locking device for a rocker-type light switch 200 installed in the single rocker-type light switch 400. The locking device for a rocker-type light switch 200 is inserted into the side air-gap 406 of the actuator 401' which is in its second position 401'. The locking device for a rocker-type light switch 200 is grasped at the two contoured surfaces 252, 230 creating a graphing feature 252, 230. The locking device for a rocker-type light switch 200 is inserted with the planar lateral surface 224 facing the actuator rim 405 and the locking tab feature 250, 211, 212 facing the actuator 401'. The locking tab feature 250, 211, 212 engage the actuator 401', holding it in place. Single rocker-type light switches 400 occasionally have undesireable “play” when only a first embodiment of locking device for a rocker-type light switch 100 is used. The second embodiment of the locking device for a rocker-type light switch 200 is designed to capture the lateral surface 440 of the actuator 401' in the locking tab 250, 211, 212 notch 214, 225. The second embodiment of the locking device for a rocker-type light switch 200 can slide along the lateral surface 440 of the actuator 401'. The second embodiment of the locking device for a rocker-type light switch 200 is positioned along the lateral surface 440 of the actuator 401' so that the lateral surface 440 is captured in the notch 214, 225 and the planar lateral surface 222 abuts the actuator rim 405.

Embodiments described above with reference to functions or acts, comprise methods. The functions/acts noted above may occur out of the order as shown or described. For example, two functions/acts shown or described in succession may in fact be executed substantially concurrently or the functions/acts may sometimes be executed in the reverse order, depending upon the functionality/acts involved. While certain embodiments have been described, other embodiments may exist. Further, the disclosed methods' functions/acts may be modified in any manner, including by reordering functions/acts and/or inserting or deleting functions/acts, without departing from the spirit of the claimed subject matter.

Although the subject matter has been described in language specific to structural features and/or methodological acts of the illustrated figures, it is to be understood that the subject matter defined in the appended claims is not necessarily limited to the specific features or acts described above. Rather, the specific features and acts described above are disclosed as example forms of implementing the claims.

I claim:

1. A locking device for a rocker-type light switch comprising:
an integral body having a first side surface defined by a piece-wise edge;
a second side surface defined by a piece-wise edge that mirrors the piece-wise edge of the first side surface;
a plurality of surfaces that adjoin both the first side surface and second side surface and which conform to the piece-wise edges defining each of the first side surface and second side surface, respectively; and
a locking feature incorporated into at least one of the plurality of surfaces;
wherein at least two of the plurality of surfaces create a grasping feature;
wherein the locking device in proximity to the locking feature is sized so that it fits into the air-gap between an actuator and an actuator rim on a rocker-type light switch;
wherein the actuator has a first position and a second position; and
wherein, when inserted into the air-gap between the actuator and the actuator rim on a rocker-type light switch, the locking feature, when engaged, prevents the actuator from moving from the first position to the second position.

2. The locking device for a rocker-type light switch in claim 1, wherein the first position is the “on” position of the rocker-type light switch.

3. The locking device for a rocker-type light switch in claim 1, wherein the first position is the “off” position of the rocker-type light switch.

4. The locking device for a rocker-type light switch in claim 1, wherein the rocker-type light switch has two actuators.

5. The locking device for a rocker-type light switch in claim 1, wherein the rocker-type light switch has a single actuator.

6. The locking device for a rocker-type light switch in claim 5, wherein the air-gap is an upper air-gap.

7. The locking device for a rocker-type light switch in claim 5, wherein the air-gap is a bottom air-gap.

8. The locking device for a rocker-type light switch in claim 1, wherein, after being inserted and engaging with the actuator, the locking device can removed by grasping the grasping feature and pulling.

9. The locking device for a rocker-type light switch in claim 1, wherein, the locking feature can be inserted into the rocker-type light by grasping the grasping feature and pushing the locking feature into the air-gap until the locking feature engages with the actuator.

10. The locking device for a rocker-type light switch in claim 1, wherein the locking feature consists of at least one protrusion extending from a planar surface.

11. The locking device for a rocker-type light switch in claim 10, wherein the protrusions engage with the actuator, preventing it the actuator from moving.

12. The locking device for a rocker-type light switch in claim 1, wherein the locking feature consists of a locking tab.

13. The locking device for a rocker-type light switch in claim 12, further comprising a notch adjacent to the locking tab.

14. The locking device for a rocker-type light switch in claim 13, wherein the rocker-type light switch has a single actuator.

15. The locking device for a rocker-type light switch in claim 14, wherein the locking device is inserted into a side air-gap.

16. The locking device for a rocker-type light switch in claim 15, wherein the locking device can be moved along the actuator rim until such time as the notch and the locking tab are fully engaged, preventing the actuator from moving.

17. The locking device for a rocker-type light switch in claim 1, wherein the integral body is fabricated from at least one of polyvinyl chloride (“PVC”), polypropylene (“PP”), acrylonitrile butadiene styrene (“ABS”), polycarbonate (“PC”), nylon, high-density polyethylene (“HDPE”), low-density polyethylene (“LDPE”), polyethylene terephthalate (“PET”) and a thermoplastic elastomer (“TPE”).
